(19) United States
(12) Patent Application Publication
(10) Pub. No.: US 2003/0041213 A1
(43) Pub. Date: Feb. 27, 2003

(54) Method and apparatus for using a cache memory

(76) Inventors: Yakov Tokar, Ashdod (IL); Yacov Efrat, Omer (IL); Doron Schupper, Rechovot (IL); Brett L. Lindsley, Wheaton, IL (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 09/938,794

(22) Filed: Aug. 24, 2001

(51) Int. Cl. G06F 12/00

(52) U.S. Cl. 711/128; 711/154

(57) ABSTRACT

A cache is used in the performance of one task that may be interrupted by another task. The first task results in the cache being loaded at least partially. The second task interrupts, but is preventing from thrashing the highest priority data. The highest priority data is not available for thrashing during the running of the second task. The second task may be interrupted as well. Similarly, the third task is prevented from thrashing the highest priority data of the second task and the first task. The third task can thrash all of the cache except that preserved for the first and second tasks. After the third task is completed, the second task can begin running again without having to reload the highest priority data. The first task is similarly completed.

### FIELD 0F THE INVENTION

This invention relates to using cache memories, and more particularly to using cache memories in a multi-tasking environment.

### BACKGROUND 0F THE INVENTION

The use of cache memories is used to improve the performance of a processing system by quickly providing information that is frequently needed. As the system is performing a task, the cache is loaded with information that is needed. As the cache is loaded, the information that has been recently used is recorded. This process continues even after the cache has been fully loaded. After the cache has been fully loaded is the time that it is most useful. In a multi-tasking system, however, another task may interrupt the task that is running in its optimum condition. The new task then overwrites the data in the cache and thus destroys most if not all of the value of having loaded the cache with the first task. The new task is allowed to interrupt because it has a higher priority. Thus, it is desirable for it to have use of the cache. The problem occurs when the first task resumes and the cache must be reloaded with the data relating to the first task. Each access outside the cache is very long compared to accesses to the cache. Having to reload the cache can have a significant impact on the time required to run the task. Further the first task may be interrupted many times so that the total amount of actual run time may be significantly increased due to having to reload the cache so many times. If the interrupts are frequent compared to the time required to load the cache, there is little benefit of having the cache at all. Thus, the cost, in a multi-tasking system, of even having a cache may exceed the benefit.

Accordingly there is a need for the ability to take advantage of the benefits of a cache in a multi-tasking system.

### BRIEF DESCRIPTION OF THE DRAWINGS

FIG. 1 is a block diagram of a circuit for operating a cache according to an embodiment of the invention;

FIG. 2 is a schematic of a memory map of the cache of FIG. 1;

FIG. 3 is a timing diagram useful in understanding the embodiment of the invention of FIG. 1; and

FIG. 4 is a further timing diagram useful in understanding the embodiment of the invention of FIG. 1

### DESCRIPTION OF THE INVENTION

Described herein is a technique that provides a way to access a cache in a multi-tasking environment. In the described embodiment, tasks utilizing the cache may be interrupted, but some portion of the cache will remain loaded with the highest priority information for the task being interrupted. The interrupting task may have the remainder of the cache available for its use including thrashing.

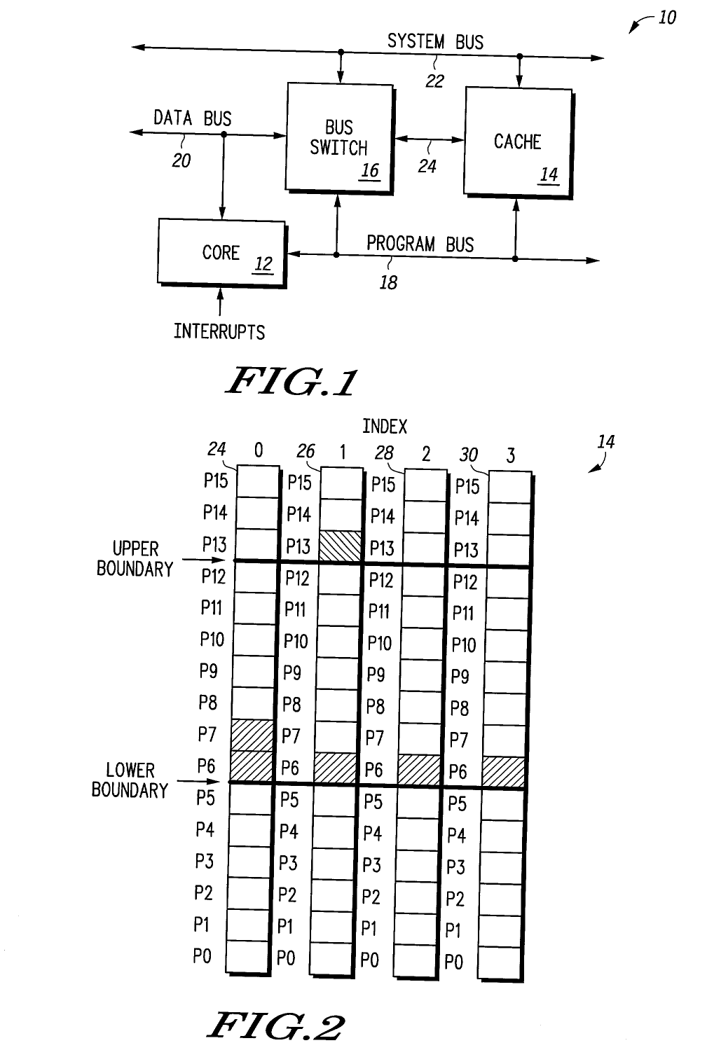

Shown in FIG. 1 is a processing system 10 comprising a core 12, a cache 14, and a cache 16. The core receives interrupts. The number of interrupts may vary but 8 is a reasonable number. Each of the interrupts has a priority with, in the example of 8 interrupts, 8 being the highest. The core is coupled to the bus switch by a program bus 18 and a data bus 20. Bus switch are both coupled to a system bus 22 and program bus 18. They are coupled together by an interconnect 24.

In operation, core 12 initiates the performance of a task. This task can have any priority, but will be the highest priority existing at the time. Core 12 will make memory accesses. As this begins, the cache will not have the required data (a miss) so that external accesses to main memory (not shown) will occur through bus switch 16 to system bus 22. As the information is returned it is provided to core 12 via bus switch and also is loaded into cache 14 via system bus 22. This process continues and as loading of cache 14 occurs, cache 14 will begin to have the requested information (a hit). As this occurs, the cache is valuable and causes the task to be completed more quickly than if all the accesses had to go to main memory. If the current task is interrupted by a higher priority, the core notifies bus switch 16 that this is going to occur via data bus 20. Bus switch 16 in turn preserves at least the most important data in the cache 14. The portion of memory in cache 14 that is blocked from writing by the new task is programmable by the core into a cache controller register in bus switch 16. The new task then may use all of cache 14 except that set aside for the first task.

Upon the completion of the new task, the first task is completed using all of cache 14 including the information that had been preserved during the performance of the new task. The information that was preserved, prevented from being thrashed, was the highest priority information for that first task. As the cache is being used by reading and writing, the status of the cache is being updated. In particular the priority of any location is updated. A common technique for this is called least recently used (LRU). A cache is organized by ways based on an index portion of the address. For each specific index there are some number of ways. A reasonable number for this is 16. Thus for a given index, each way within that index is prioritized with LRU bits. For a write into cache 14, the way written is the one with the lowest LRU priority. Thus, at a given point in time, the most important information is located at those ways that have the highest priority LRU bits. Thus, for the case here in which the first task is interrupted, the ways that contain the most useful information are those with the highest priority LRU bits. Thus, it makes sense to select those as the ones that will be preserved. The user has the ability to program the bus switch 16 to select the ways that are available based on these LRU bits. Bus switch 16 provides the information on what range of LRUs are available for accessing by the new task, which is the interrupting task.

Shown in FIG. 2 is a bit map of cache 14 comprising a line 24, priority line 26, line 28, and line 30. Each line 24-30 contains ways whose priorities are P0-P15 and are shown as organized by priority in FIG. 2. Each way has a physical location and logical address that is conceptually different from its priority. The way with the priority of P15, the highest priority, can be located anywhere in the line in terms of it physical location and logical address. Bus switch 16, however, selects the range of available ways based on the LRU bits that define the priority.

Shown in FIG. 2 is a selection of an available range of P6-P12. Normally the expectation is that a user will have an available range beginning with P0 for the case where the interrupting task will finish before the one being interrupted will be resumed (single stack model), but this is to show the capability of bus switch 16 with cache 14. This capability is useful in multi-stack operation, which is for the situation in which the tasks don't really finish but stay in the background. For such a case, it may be desirable to have a portion of cache dedicated to each of the tasks. For example, for a given interrupt, there will always be a portion of the memory dedicated for it. Thus, the range for such a situation may be that shown in FIG. 2, that the task for the particular interrupt has available to it the range of LRUs from P6 to P12. Another task from another interrupt may have a portion between P0 and P5. Each task would thus have a portion of memory that it will always access for writing. The portion outside the selected LRU range will not be effected. Generally, the whole cache is available for reading because that does not alter the data and thus adversely affect other tasks.

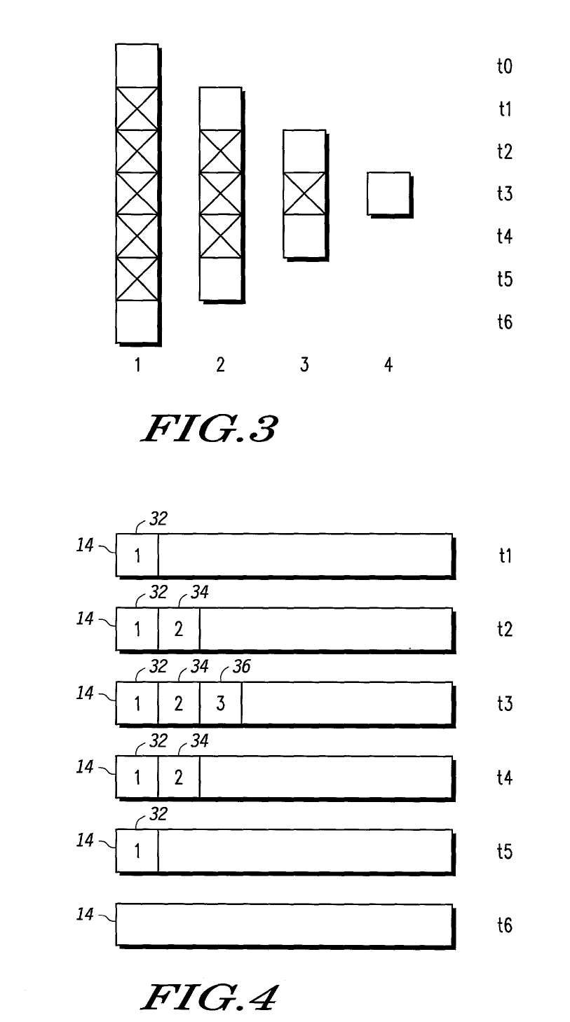

Shown in FIGS. 3 and 4 is an example for single stack operation in which task 1, task 2, task 3, and task 4 are performed. In this case, the order of priority is from lowest to highest, tasks 1-4. The operation commences with task 1 running during time in which all of cache 14 is available to perform task 1. Task 2 interrupts task 1 and is performed during time t1. As shown in FIGS. 3 and 4, task 1 is not being performed and a portion 32 of cache 14 is not available for accessing for writing during t1 in the performance of task 2. This portion 32 has the highest priority LRU bits. Task 3 interrupts task 2 so that during time t2, task 2 is stopped and a further portion 34 is not available for accessing for writing in the performance of task 3. Portion 34 has the next highest LRU bits from those in portion 32. Thus the availability for thrashing in the performance of task 3 is to all the cache except for portions 32 and 34. Task 4 similarly interrupts task 3 so that during time t3, task 4 is running and an additional portion 36 is prevented from being thrashed. After task 4 is completed, task 3 starts running again with all of cache 14 available except portions 32 and 34 until completed during time t4. The finalizing of task 3 may thrash data from task 4 because task 4 was running only lowest priority portion of cache 14. This is not a problem because task 4 has been completed. After task 3 is completed, task 2 is completed during time t5. Then after task 2 is completed, task 1 is completed during time t6. Under this sequence, the next task, because there are no interrupted tasks, will have the whole cache 14 available for thrashing.

Although the total time elapsed for a task from start to finish depends on the amount of time the task is interrupted. The run time, however, does not include the time interruption time. In this case, the worst case run time for a task is predictable. The run time is based in part on the size of a cache that is being used. If the task is interrupted and the cache is thrashed, the time to reload the cache upon starting running again adds significant time. With the processing system 10 of FIG. 1, there is available the option of having a minimum amount of cache preserved for an interrupted task. The task may have in fact more than that minimum much of the time, but that minimum amount preserved is ensured. Thus, for figuring the worst case run time, that minimum amount of cache can be used in the calculation. A worst case analysis can be important in some systems. For example, real time systems, such as cell phones, typically need this information.

Thus, with the cache mapping based on LRU bits, the ability to achieve needed utility of a cache in a multi-tasking environment is achieved.

1. A method for running tasks, comprising the steps of:
providing a cache having a group of ways, wherein the ways are prioritized in response to usage;
beginning running a first task using the cache;
interrupting the running of the first task to begin running a second task using the cache; and
preventing the running of the second task from thrashing a first subset of the group of ways, wherein the first subset comprises a first plurality of ways having a higher priority than the other ways prior to running the second task.

2. The method of claim 1, further comprising completing the running of the first task after completion of the second task using the first subset of ways and the other ways.

3. The method of claim 2, further comprising:
interrupt the running of the second task to begin running a third task using the cache; and
preventing the running of the third task on the first subset and on a second subset of the group of ways, wherein the second subset comprises a second plurality of ways having a lower priority than the ways in the first subset and higher than the remaining ways.

4. The method of claim 3, further comprising completing the running of the second task after completion of the third task using the second subset of ways and the remaining ways.

5. The method of claim 4, further comprising
interrupt the running of the third task to begin running a fourth task using the cache; and
preventing the running of the fourth task on the first subset, the second subset, and on a third subset of the group of ways, wherein the third subset comprises a second plurality of ways having a lower priority than the ways in the second subset.

6. A method for running tasks, comprising the steps of:
providing a cache having a group of ways;
begin running a first task using a first subset of the group ways;
interrupt the running of the first task to begin running a second task using a second subset of the ways; and
preventing the running of the second task from thrashing the first subset of the group of ways.

7. The method of claim 6 further comprising:
interrupt the running of the second task to begin running a third task using a third subset of the ways; and
preventing the running of the third task from thrashing the first and second subsets of the group of ways.

8. A circuit, comprising:
a cache having a group of ways, wherein the ways are prioritized in response to usage;
a core, coupled to the cache, for running tasks and interrupting the running of a first task to run a second task having a higher priority than the first task; and
a cache controller, coupled to the cache and the core, for forming a subset of the group of ways based on having a higher priority than the other ways and for preventing the subset from being accessed during the running of the second task.

9. The circuit of claim 8, further comprising:
a program bus for coupling the core to the cache and the cache controller.

10. The circuit of claim 8, wherein the cache controller is further characterized as basing the higher priority on usage.
a program bus for coupling the core to the cache and the cache controller.

11. A circuit, comprising:
a cache having a group of ways;
a core, coupled to the cache, for running tasks and interrupting the running of a first task to run a second task having a higher priority than the first task; and
a cache controller, coupled to the cache and the core, for forming a first subset of the group of ways to be accessed by the core during the running of the first task and prevented from being accessed by the core during the running of the second task and for forming a second subset of the group of ways to be accessed by the core during the running of the second task.

12. The circuit of claim 11, wherein the cache is further characterized as prioritizing the ways in response to usage and the cache controller is further characterized as forming the first subset with the ways that have a higher priority than the other ways.

13. The circuit of claim 11, wherein the core is further characterized as being for interrupting the second task to run a third task and wherein the cache controller is further characterized as being for forming a third subset of the group of ways to be accessed during the running of the third task and for preventing the access of the second subset during the running of the third task.

14. A method of running a first task within a first time and a second task within a second time, comprising:
determining the first run time of the first task using a first amount of cache;
determining the second run time of the second task using a second amount of cache;
running the first task using at least a first portion of a cache having an amount of cache of at least the first amount of cache plus the second amount of cache;
interrupting the first task with a second task;
preventing the second task from thrashing the first portion of the cache;
running the second task using at least a second portion of the cache having at least the second amount of cache; and
finishing the first task using at least the first amount of cache after the second task is completed.

15. The method of claim 14, wherein the step of finishing is further characterized as using the first amount of cache and the second amount of cache, whereby the first task is completed faster than the first time.

16. The method of claim 14, wherein the step of running the first task is further characterized as using the entire cache.
